(19) United States
(12) Patent Application Publication
(10) Pub. No.: US 2023/0109905 A1
(43) Pub. Date: Apr. 13, 2023

(54) BOT PROCESSING AUTOMATION USING KNOWLEDGE BASE IN CONTEXTUAL ARTIFICIAL INTELLIGENCE

(71) Applicants: Waterlabs AI Technologies Private Limited, Bengaluru (IN); Waterlabs AI LLC, Wilmington, DE (US)

(72) Inventor: KAMALRAJ CHANDRASEKARAN, Bengaluru (IN)

(73) Assignees: Waterlabs AI Technologies Private Limited, Bengaluru (IN); Waterlabs AI LLC, Wilmington, DE (US)

(21) Appl. No.: 17/962,612

(22) Filed: Oct. 10, 2022

(30) Foreign Application Priority Data
Oct. 9, 2021 (IN) 202111046098

(51) Int. Cl. G06N 5/022; G06V 30/41; G06V 30/16

(52) U.S. Cl. CPC G06N 5/022; G06V 30/41; G06V 30/16

(57) ABSTRACT

A system and method for bot processing automation are provided. The system includes a processor. The system also includes a memory comprising a set of instructions, which when executed by the processor cause the processor to: receive, from a repository, the images from VDI are converted to user defined text input (CSV, XLSX, etc.,) and uses the contextual AI that can contribute to the accuracy improvement and can help to build the context for the domain knowledge base. We use Named Entity Recognition (NER) technique in Natural Language Processing (NLP) for tagging the fields and associate with knowledge graphs. With this information, the contextual AI can act like a wrapper to the BOT and validate the front end rejections.

### FIELD OF DISCLOSURE

The present disclosure relates to process automation. More particularly, the present disclosure relates to a system and method for bot process automation using knowledge base in contextual artificial intelligence (AI).

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

With the linear growth in technology, use of artificial intelligence and machine learning techniques are finding applications in almost all the areas. One such major application is in the process automation, where virtual assistants referred to as ‘bots’ are being used. An operation or a method used to control and automate any processes. Bots are used for digitally interpreting and providing responses to expressions of intent, such as online chat sessions, content recognition, or web content, present significant opportunities for new and improved modes of interaction between humans and computer systems.

Several processes workflow automation present, mainly focused on maintaining electronic records, accelerating help desk response time, operations associated to entities, managing behavioral aspects of users associated to any institution, and the like. But no process has focused on automating the system with minimal or no human intervention; and end-to-end data processing from getting an input and extracting data from the input to create readable output files and perform the entire end-to-end data processing without any human intervention.

In addition, most of the process automation techniques are limited to text or content extraction, where a user needs to input the data in any forms which is converted into machine readable content by the bots. Due to the intervention of human to achieve such a process, the system and the processing of data is prone to errors, due to which such approaches becomes less reliable. In addition, as the retrieving of data is in the user's hands, security of the content of the data is sometimes compromised as there are possibilities where a third party or the user alone can breach the content of the data or the input to be analyses during the process automation, which results in varied output, which is less reliable.

Therefore, there is a need in the art to provide an improved system and method for bot process automation using knowledge base in contextual artificial intelligence (AI) which overcomes above-mentioned and other limitations of existing approaches.

### OBJECTS OF THE INVENTION

Some of the objects of the present disclosure, which at least one embodiment herein satisfies, are as listed herein below.

It is an object of the present disclosure to provide system and method for bot process automation using knowledge base in contextual artificial intelligence (AI).

It is another object of the present disclosure to provide end to end data processing for bot process automation without any human intervention.

It is yet another object of the present disclosure to provide tracking facility for a end user to know the status of the data processing.

It is yet another object of the present disclosure to provide system and method for bot process automation to analyse input data for corresponding records of an entity.

It is yet another object of the present disclosure to provide system and method for bot process automation which contribution towards increasing completeness of the process.

It is yet another object of the present disclosure to provide system and method for bot process automation to improve the entity extraction and information access.

It is yet another object of the present disclosure to provide system and method for bot process automation improve the quality of service of a system architecture.

It is yet another object of the present disclosure to provide an optimum use of the system with minimal efforts of human.

It is yet another object of the present disclosure to provide a cost effective in terms of technical specifications as the hardware and the services involved in the process automation is reduced.

It is yet another object of the present disclosure to provide a system and method for bot process automation which is more user friendly, more reliable, more transparent and more efficient.

It is another object of the present disclosure to provide an intelligence system to self-organize the bot with reasoning capability.

It is another object of the present disclosure to enable the system to auto correct the text based on the context using AI techniques.

### SUMMARY

This summary is provided to introduce simplified concepts of a system and method for dynamic evasive trajectory planning of a host vehicle on a road, which are further described below in the Detailed Description. This summary is not intended to identify key or essential features of the claimed subject matter, nor is it intended for use in determining/limiting the scope of the claimed subject matter.

The present disclosure relates to process automation. More particularly, the present disclosure relates to a system and method for bot process automation using knowledge base in contextual artificial intelligence (AI).

An aspect of the present disclosure relates to a system for bot processing automation. The system includes a processor. The system also includes a memory comprising a set of instructions, which when executed by the processor cause the processor to: receive, from a repository, an image, and process said image using optical character recognition (OCR) to generate a first output; process any or a part of said image and said generated first output using contextual artificial intelligence (AI) to generate a second output, said contextual AI being based on a combination of a neural network, one or more knowledge graphs, and natural language processing (NLP) and facilitate use of said second output and said one or more knowledge graphs for bot automation to validate and build interdependency among one or more fields that form part of said image.

Another aspect of the present disclosure relates to a method for bot processing automation. The method includes receiving, from a repository, through a processor, an image, and processing said image using optical character recognition (OCR) to generate a first output; processing any or a part of said image and said generated first output using contextual artificial intelligence (AI) to generate a second output, said contextual AI being based on a combination of a neural network, one or more knowledge graphs, and natural language processing (NLP); and facilitating use of said second output and said one or more knowledge graphs for bot automation to validate and build interdependency among one or more fields that form part of said image.

Various objects, features, aspects and advantages of the present disclosure will become more apparent from the following detailed description of preferred embodiments, along with the accompanying drawing figures in which like numerals represent like features.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates an exemplary block diagram of a system for bot processing automation in accordance with an aspect of the present invention.

FIG. 2 illustrates another exemplary representation of system on a centralized server for bot processing automation in accordance with an aspect of the present invention.

FIG. 3 illustrates another exemplary representation of a system architecture for bot processing automation using knowledge base in contextual artificial intelligence in accordance with an aspect of the present invention.

FIG. 4 illustrates another exemplary representation of a flow chart representing steps involved for processing insurance claims for a patient of FIG. 1 in accordance with an aspect of the present invention.

FIG. 5 illustrates another exemplary representation of a flow chart representing steps involved in process of knowledge matching of FIG. 1 in accordance with an aspect of the present invention.

FIG. 6 illustrates exemplary method flow diagram depicting a method for facilitating process automation from an input image in accordance with an aspect of the present invention.

FIG. 7 illustrates exemplary method flow diagram depicting a method involved in end-to-end process automation using knowledge base in contextual artificial intelligence in accordance with an aspect of the present invention.

FIG. 8 illustrates exemplary method flow diagram depicting a method for bot processing automation in accordance with an aspect of the present invention.

FIG. 9 refers to the exemplary computer system in which or with which embodiments of the present invention can be utilized, in accordance with embodiments of the present disclosure.

FIG. 10 illustrates architectural overview depicting a method for bot processing automation in accordance with an aspect of the present invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Embodiments of the present invention may be provided as a computer program product, which may include a machine-readable storage medium tangibly embodying thereon instructions, which may be used to program a computer (or other electronic devices) to perform a process. The term “machine-readable storage medium” or “computer-readable storage medium” includes, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).A machine-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Various terms as used herein are shown below. To the extent a term used in a claim is not defined below, it should be given the broadest definition persons in the pertinent art have given that term as reflected in printed publications and issued patents at the time of filing.

The present disclosure relates to process automation. More particularly, the present disclosure relates to a system and method for bot process automation using knowledge base in contextual artificial intelligence (AI).

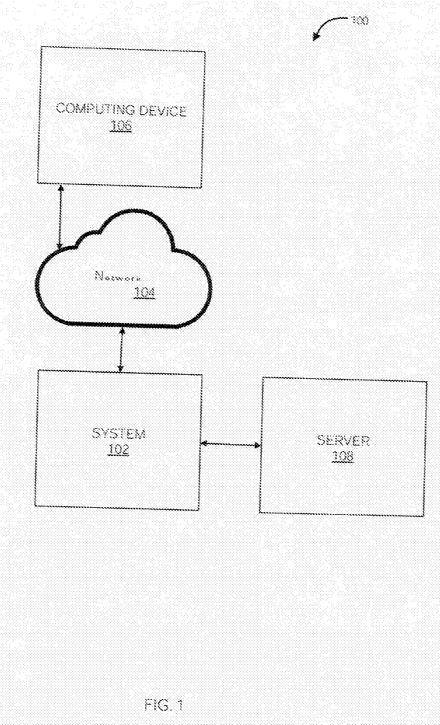

FIG. 1 illustrates an exemplary block diagram 100 of a system 102 for bot processing automation in accordance with an aspect of the present invention. The system 102 includes one or more processors that runs on a computing device 106. The one or more processors of a server 108 being operatively coupled with a memory that stores one or more executable instructions in a manner such that when the one or more processors execute a part of the one or more executable instructions, the one or more processors is configured to function as described herein. The computing device 106 is connected to the system 102 via a network 104. In one embodiment, the network may be a wired or a wireless communication medium.

The system 102 includes a processor. The system also includes a memory comprising a set of instructions, which when executed by the processor and cause the processor to receive an image, and process said image using optical character recognition (OCR) to generate a first output. The image is received from a repository. In one embodiment, the first output may be textual data retrieved from the image. In one exemplary embodiment, the image may include one or more details associated to a specific entity, wherein the entity may be one of a user, an organization, an institution, or the like. In such embodiments, the data contained in the image may be handwritten data which may be scanned to obtain the image, may be computer printed image, or the like. Further, the OCR is applied on the image to convert the text in the image into corresponding machine-readable data which may be presented as the first output. In some embodiment, the image may also include one or more sub-images which may include data in the form of text, graphics, or the like. As used herein, the term ‘optical character recognition (OCR)’ may be defined an electronic or mechanical conversion of images of typed, handwritten or printed text into machine-encoded text, whether from a scanned document, a photo of a document, a scene-photo, from subtitle text superimposed on an image.

Further, the system 102 is configured to process any or a part of the image and generated first output using contextual artificial intelligence (AI) to generate a second output, said contextual AI being based on a combination of a neural network, one or more knowledge graphs, and natural language processing (NLP). As used herein, the term ‘artificial intelligence’ is defined as an intelligence demonstrated by machines, unlike the natural intelligence displayed by humans and animals, which involves consciousness and emotionality. Also, the term ‘contextual AI’ is defined as technology under the AI that is embedded into a system to understands human context and is capable of interacting with humans. Further, the term ‘neural network’ is defined as network or circuit of neurons, or in a modern sense, an artificial neural network, composed of artificial neurons or nodes. Also, the term ‘knowledge graph’ is defined as a knowledge base that uses a graph-structured data model or topology to integrate data. Knowledge graphs are often used to store interlinked descriptions of entities such as objects, events, situations or abstract concepts with free-form semantics. Further, the term ‘natural language processing’ is defined as a subfield of linguistics, computer science, and artificial intelligence concerned with the interactions between computers and human language, in particular how to program computers to process and analyze large amounts of natural language data. The analysis result is a computer capable of understanding the contents of documents, including the contextual nuances of the language of the data. In one embodiment, the second output may include textual data retrieved from the image. In one exemplary embodiment, based on the validation and built interdependency, any or a combination of said neural network and the one or more knowledge graphs are updated to provision intelligence to the bot automation.

In one exemplary embodiment, at least one of the one or more knowledge graphs represents knowledge in an area of interest using a graph-like structure. The at least one knowledge graph being built on top of a plurality of existing databases so as to link data together by combining structured and unstructured information. In such embodiment, the at least one knowledge graph is generated and updated based on deep learning enabled through said neural network, said NLP, said OCR, and the bot automation, wherein the at least one knowledge graph may be processed to indicate any or a combination of geo-location of a user, demographic information associated with the user, a health attribute associated with the user, and one or more parameters pertaining to the user, if the bot automation is implemented on a computing device associated to a medical institution such as a hospital, a health insurance firm, or the like. Further, in such embodiment, the at least one knowledge graph may be generated for or associated with a healthcare patient, and may include interrelationships between name of the patient, location of the patient, and a unique subscriber identifier associated with said patient.

In another exemplary embodiment, the neural network may include a knowledge matching engine that may receive input features from a plurality of sources, and may processes the input features using one or more hidden layers and computational units to generate output predictions that may be used for updating the one or more knowledge graphs. In one embodiment, the plurality of sources may include at least one of an internal source or an externa source.

Furthermore, the system 102 is configured to facilitate use of the second output and the one or more knowledge graphs for bot automation to validate and build interdependency among one or more fields that form part of the image.

In one exemplary embodiment, the processing of said image based on the OCR may include pre-processing image data associated with the received image. Further, detecting any or a combination of lines, words or characters from the processed image. Consequently, post-processing detected characters for rendering text as output based on the post-processed detected characters. In such embodiment, the pre-processing method may be applied on the image to perform error correction, brightness adjustment, contrast adjustment, or the like. Further, the processing of the image may include extraction of content or data from the image via bot automation.

In one exemplary embodiment, the system 102 for bot processing automation may be applied in a healthcare infrastructure in order to maintain health insurance process and claims of a user. The user initially may log into a dashboard and access a corresponding user profile which may be created on the centralized platform upon providing a plurality of use details. On a dashboard associated to the centralized platform, the user may select healthcare option and go to operations, then from data processing, the user may select Production BOT post which the user may opt for the RCM company's EV Virtual desktop infrastructure (VDI). Upon selecting the same, the system 102 logs into the RCM company's SSO application with RPM login credentials and then in the RPM message board via the Bot. the bot may click on Accession and then on Detail and puts an accession Id, wherein the accession ID may be associated to the user and/or the user login credentials. Further, the Bot checks if Original Balance amount and Balance Due is the same, further to which the bot verifies if patient ID, rejection case, and rectification to resolve rejection of insurance claims and the same may be updated in a notes section by the bot. Then the BOT goes to the payor company's portal and logs in and clicks on the EB icon to go to the insurance search page to update the patient details and check the insurance status. After the bot chooses the appropriate payer and provider, the bot may update a date of service from a spreadsheet. The bot takes the date of birth from the RCM company and the patient ID from the spreadsheet and may add them on a payor company's page and may select a submit option.

Furthermore, the bot may fill a subscriber ID associated to the health insurance policy, in the payor info tab in the RCM company's software and may click on a checkbox to check on the eligibility criteria of the user to claim the insurance benefits. In a scenario where the bot identifies and error, the bot may go to the RCM company's Accession Errors tab and clicks on the “Fix Error” checkbox and saves the selected option. Then the bot clicks on “Add contact note” and enters notes in the Contact info field as “Updated patient ID from existing ID TO an updated ID as per payor company and click Save in a pop-up window. Then the bot proceeds to click a Save button in a menu bar available at the bottom of the RCM company's screen. Post completion of these steps, the Accession Errors window will clear all error messages, and the account is cleared for filing. Then the bot goes to the contact notes tab to check the updates.

Here the BOT may now open a web browser and may enter the user's dashboard, with a corresponding URL, and may log into the application using the user's login credentials. Then the bot selects an insurance provider's name and clicks on appropriate options to add a new batch number to post the ERA, and the bot adds and updates the batch number. Then the BOT goes to the homepage and clicks on billing, and chooses ERA(s)/Check, and then the BOT selects pending post ERA. Consequently, the bot selects a cheque number from the spreadsheet, which is provided to the bot and searches the cheque number to click on the post remittance. Then the BOT selects the appropriate batch and clicks on continue, and the BOT checks if the process is successfully done or not.

Furthermore, if the user who may be referred to as a patient, has updated insurance, the BOT would have to update that insurance to the application on the centralized platform. Under a Row tab—insurance coverage and column tab—user decision, the bot may select write/override out of several options present in the drop-down menu. If still the same insurance is found, the BOT will have to skip the patient and go to the next patient and select a different patient, going further the bot will click on the process and reprocess. Similarly, the bot has to process all the records for every patient who is having “Prompt Need Attention” status thereby automating an end-to-end non-VDI data processing.

The same automation process may be applied on any application software having same or similar process steps.

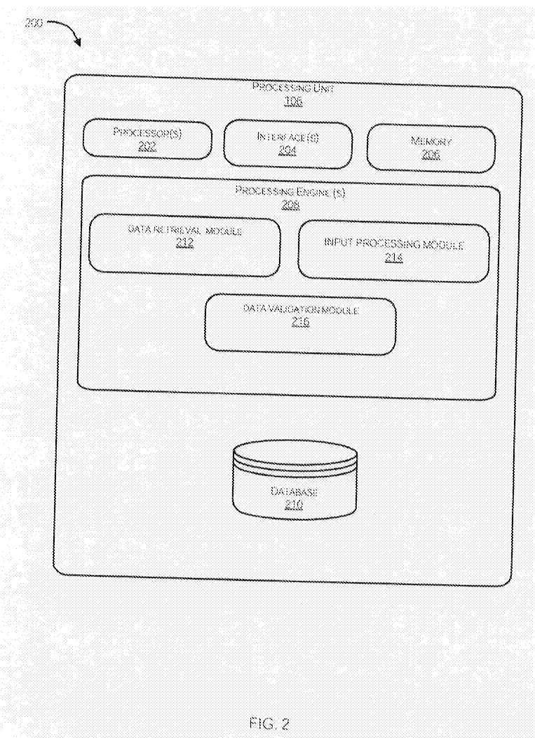

FIG. 2 illustrates another exemplary representation of system on a centralized server for bot processing automation in accordance with an aspect of the present invention. In an aspect, module diagram 200 of the system 102 which may include one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 are configured to fetch and execute computer-readable instructions stored in a memory 204 of the system 102. The memory 204 may store one or more computer-readable instructions or routines, which may be fetched and executed to create or share the data units over a network service. The memory 204 may include any non-transitory storage device including, for example, volatile memory such as RAM, or non-volatile memory such as EPROM, flash memory, and the like.

The system 102 may also include an interface(s) 206. The interface(s) 206 may include a variety of interfaces, for example, interfaces for data input and output devices, referred to as I/O devices, storage devices, and the like. The interface(s) 206 may facilitate communication of system 102. The interface(s) 206 may also provide a communication pathway for one or more components of the system 102. Examples of such components include, but are not limited to, processing engine(s) 208 and a database 210.

The processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may include a processing resource (for example, one or more processors), to execute such instructions. In the present examples, the machine-readable storage medium may store instructions that, when executed by the processing resource, implement the processing engine(s) 208. In such examples, the system 102 may include the machine-readable storage medium storing the instructions and the processing resource to execute the instructions, or the machine-readable storage medium may be separate but accessible to system 102 and the processing resource. In other examples, the processing engine(s) 208 may be implemented by electronic circuitry.

The database 210 may include data that is either stored or generated as a result of functionalities implemented by any of the components of the processing engine(s) 208 or the system 102. With reference to FIG. 1, the present disclosure relates to system and method bot process automation using knowledge base in contextual artificial intelligence (AI). In order to enable the automation of the system, a data retrieval module 212 may receive the data in a form of an image, which may be further processed by an input processing module 214 using optical character recognition (OCR) to generate a first output. The input processing module 214 may be further configured to process any or a part of the image and the generated first output using contextual artificial intelligence (AI) to generate a second output. The contextual AI may be generated based on a combination of a neural network, one or more knowledge graphs, and natural language processing (NLP). Furthermore, a data validation module 216 may use the second output and the one or more knowledge graphs for bot automation in order to validate and build interdependency among one or more fields that form part of the image received by the data retrieval module 212.

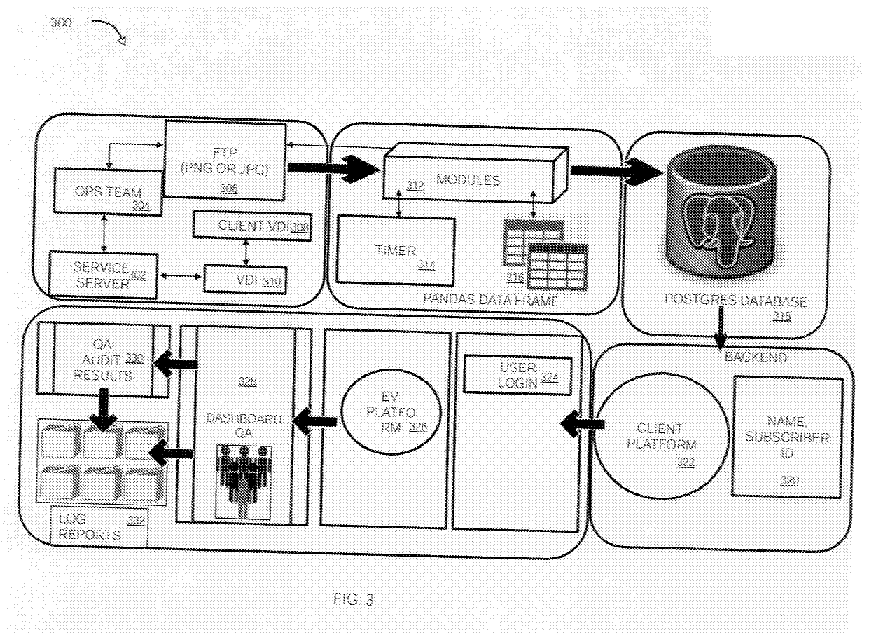

FIG. 3 illustrates another exemplary representation of a system architecture 300 for bot processing automation using knowledge base in contextual artificial intelligence in accordance with an aspect of the present invention. The architecture 300 may include a service server 302 which may be operatively coupled to an entity associated to an OPS team 304. Further, the OPS team may be integrated with a file transfer protocol 306 which may be configured to receive input files in one of a jpg form, a png form, a pdf form, or the like. The service server 302 may be associated with a client VDI 308 and a centralized VDI 310.

Further, the input which may be received on the FTP 306 may be transmitted to a plurality of modules 312 which may be operatively coupled to one or more timer 314 to form a data frame 316. In one example, a pandas data frame which is a heterogeneous tabular data structure with labeled axes associated to sections, subsections or categories of the application on which the bot process may be initiated. Using the corresponding modules 312, the data may be stored in a database 318, for example a Postgres database which may be functioning at a backend, where the database may be categorized based in name, subscriber ID, and the like 320. Also, the database may be coupled to a client platform 322 at the backend.

The client platform 322 may be accessed via a user login dashboard 324, post to which the validation of the data may take place on an EV platform 326. The validated results may be displayed on a dashboard QA 328, which may be further audited to generate QA audit results 330 which may be represented as log reports 332 on the centralized platform or in the database.

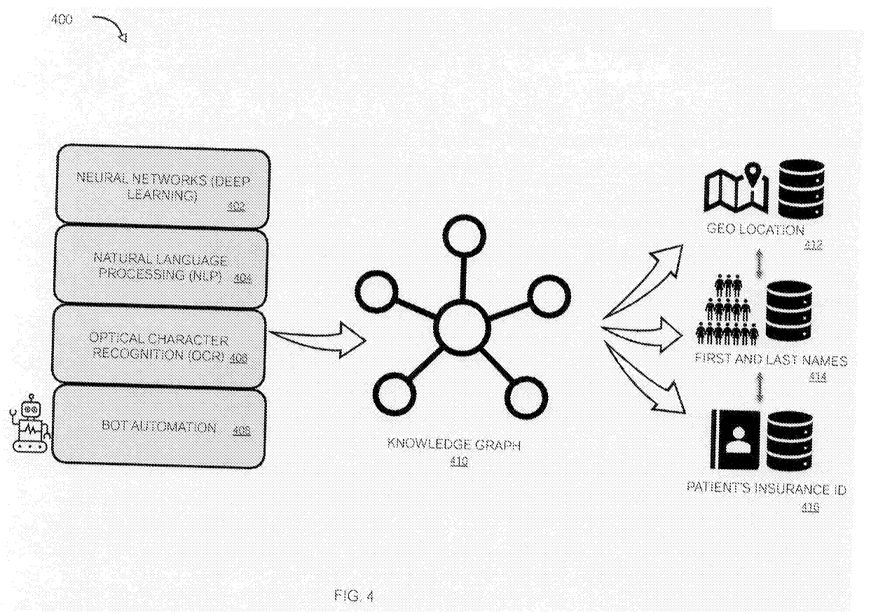

FIG. 4 illustrates another exemplary representation of a flow chart 400 representing steps involved for processing insurance claims for a patient of FIG. 1 in accordance with an aspect of the present invention. A set of techniques such as neural networks 402, natural language processing 404, optical character recognition 406 are applied on input which may be in a form of an image in order to extract the content of the image and initiate the further processing and validation of the input data using a bot automation 408. Upon applying the set of instruction on the input image, a knowledge graph 410 may be extracted in context of the application on which the bot automation 408 may be implemented. For example, if the application is the medical insurance platform, multiple data such as geo location 412, first and last name of multiple users 414, patient's insurance ID 416, and the like may be extracted and verified using the generated knowledge graph.

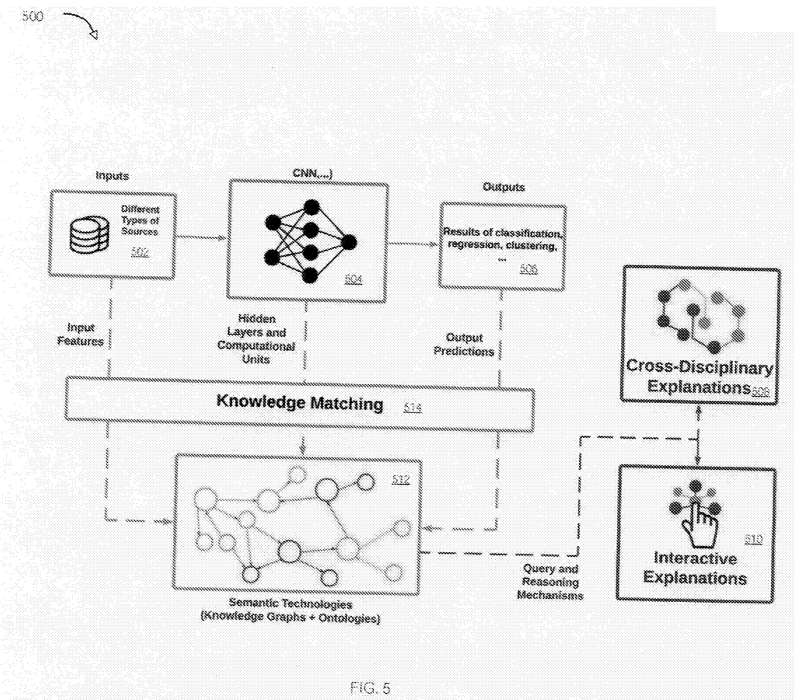

FIG. 5 illustrates another exemplary representation of a flow chart 500 representing steps involved in process of knowledge matching of FIG. 1 in accordance with an aspect of the present invention. Initially a set of data in a form of input may be received form various sources 502 may be received by a system onto which a convolution neural network 504 may be used to extract multiple hidden layers and computational units and generate output 506 which may be a result of classification, regression and clustering. Further, a knowledge matching technique 514 may be used in order to extract input features, hidden layers and computational units, and also to predict the output.

Furthermore, using the input features and the output predictions, knowledge graphs and ontologies may be generated using semantic technologies 512. Further a plurality of queries and reasoning mechanisms associated to the knowledge graphs may be subjected to cross disciplinary explanations 508 and interactive explanations 510 in order to rectify the one or more faults in the process automation using the bot.

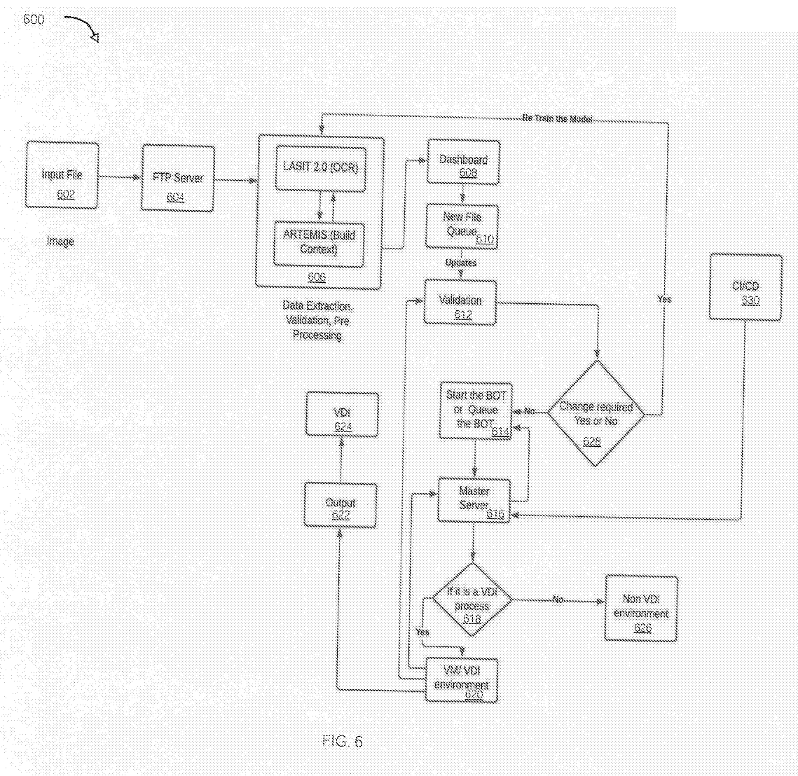

FIG. 6 illustrates exemplary method flow diagram depicting a method 600 for facilitating process automation from an input image in accordance with an aspect of the present invention. The process automation is initiated upon receiving an input file 602 in a form of an image, which is transmitted to an FTP server 604. The input is subjected to pre-processing to extract data and validate the extracted data using OCR such as LASIT 2.0 and ARTEMIS using multiple AL and ML techniques. Further to the pre-processing, a dashboard 608 may be created from which a new file queue 610 may be generated. On receiving any further updates on the file which may be queued further validated 612. In case any modification needs to be made in the existing data upon verifying the condition status for changes required 628, the same may be subjected to pre-processing again and the process may continue.

If there are no changes required, the bot is initiated to operate 614 on a master server 616 and the same if validated to check if the process is a VDI process in step 618, if the process is received as a VDI process, the data from the VDI environment is transmitted to the master server 616. If the process is identified as a non VDI process, the validation may be terminated to a non-VDI environment 626. Also, the data from the VDI environment 620 may be transmitted to as output 622 and further as VDI 624. In addition, data from CI or CD is also transmitted to the master server 616 for validation and processing.

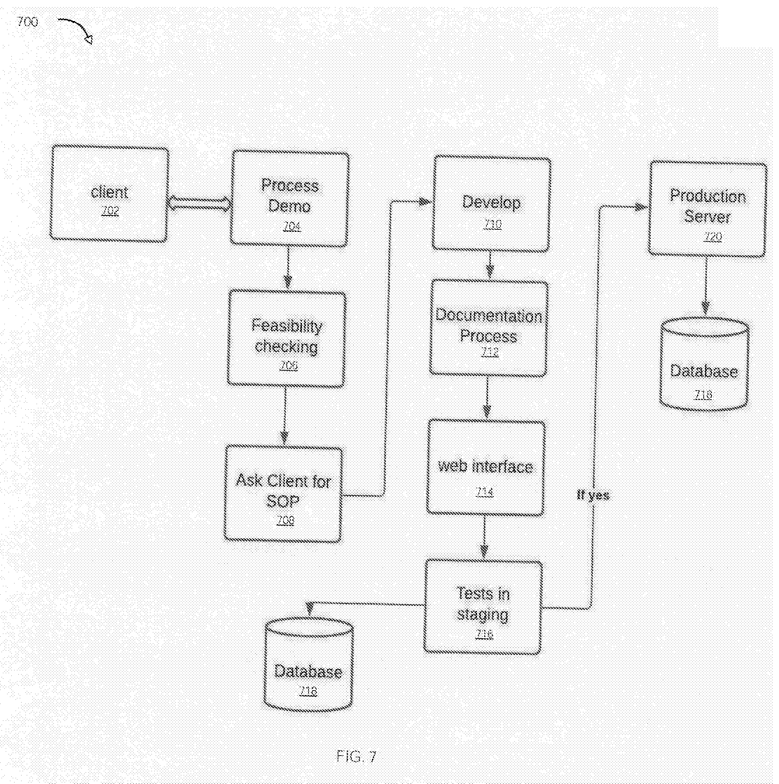

FIG. 7 illustrates exemplary method flow diagram depicting a method 700 involved in end-to-end process automation using knowledge base in contextual artificial intelligence in accordance with an aspect of the present invention. The method 700 initially includes a client 702 accessing a process demo 704 and check for the flexibility 706. An SOP from a client is requested on checking the flexibility 708. On receiving the SOP from the client, an architecture for implementing the BOT process automation onto a system is developed 710. On developing the architecture, documentation process is initiated 712 upon receiving all the corresponding inputs from one or more sources, a web interface may be created 714 to enable the client or any other authorized entity to access the process. Further, the testing of the architecture is initiated to check if the tests are in the staging process 716, if no then the data is stored in a database 718. If the tests are found to be in the staging process, the same is sent to a production server 720 and further data gets stored in the database 718.

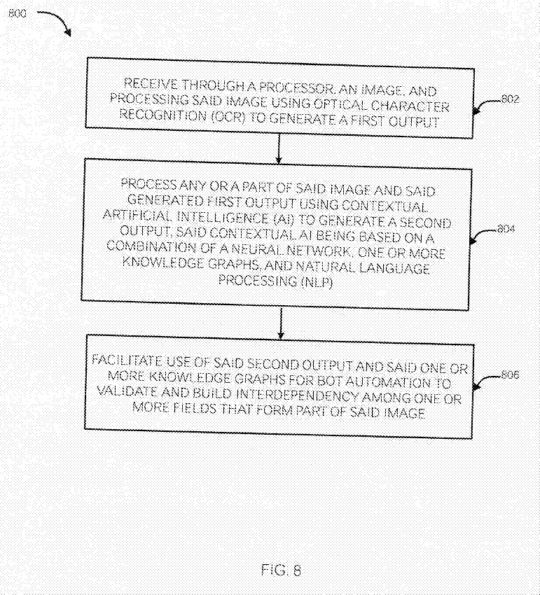

FIG. 8 illustrates exemplary method flow diagram depicting a method 800 for bot processing automation in accordance with an aspect of the present invention. The method 800 includes receiving, from a repository, an image, and processing said image using optical character recognition (OCR) to generate a first output in step 802. In one embodiment, receiving the image may include receiving the image by a processor.

The method 800 also includes processing any or a part of said image and said generated first output using contextual artificial intelligence (AI) to generate a second output, said contextual AI being based on a combination of a neural network, one or more knowledge graphs, and natural language processing (NLP) in step 804.

Furthermore, the method includes facilitating use of said second output and said one or more knowledge graphs for bot automation to validate and build interdependency among one or more fields that form part of said image in step 806. In one embodiment, at least one of the one or more knowledge graphs represents knowledge in an area of interest using a graph-like structure, the at least one knowledge graph being built on top of a plurality of existing databases so as to link data together by combining structured and unstructured information. In such embodiment, the at least one knowledge graph is generated and updated based on deep learning enabled through the neural network, the NLP, the OCR, and the bot automation, wherein the at least one knowledge graph is processed to indicate any or a combination of geo-location of a user, demographic information associated with the user, a health attribute associated with the user, and one or more parameters pertaining to the user. In such another embodiment, the at least one knowledge graph is generated for or associated with a healthcare patient, and comprises interrelationships between name of the patient, location of the patient, and a unique subscriber identifier associated with said patient.

In one embodiment, based on the validation and built interdependency, any or a combination of said neural network and the one or more knowledge graphs are updated to provision intelligence to the bot automation.

In one exemplary embodiment, the neural network may include a knowledge matching engine that receives input features from a plurality of sources, and processes said input features using one or more hidden layers and computational units to generate output predictions that are used for updating the one or more knowledge graphs.

Furthermore, the processing of the image based on the OCR may include pre-processing image data associated with said received image; detecting any or a combination of lines, words or characters; post-processing detected characters and rendering text as output based on the post-processed detected characters. In such embodiment, any or both of the first output and the second output may be textual data retrieved from the image.

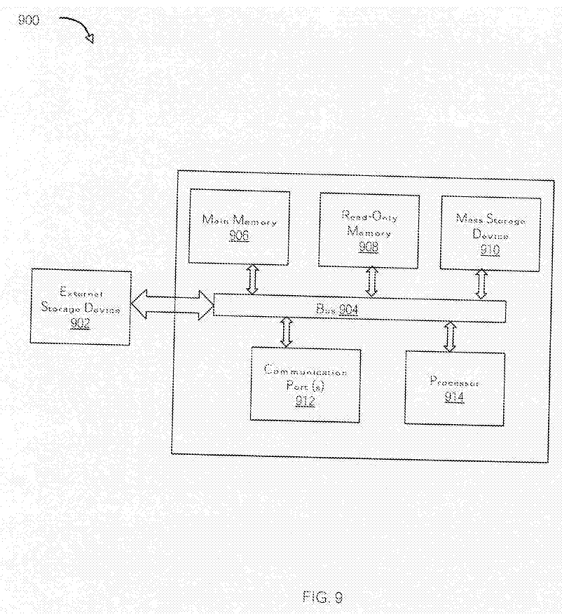

FIG. 9 refers to the exemplary computer system 900 in which or with which embodiments of the present invention can be utilized, in accordance with embodiments of the present disclosure. As shown in FIG. 9, computer system 900 can include an external storage device 902, a bus 904, a main memory 906, a read only memory 908, a mass storage device 910, communication port 912, and a processor 914. A person skilled in the art will appreciate that the computer system may include more than one processor and communication ports. Examples of processor 914 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 914 may include various modules associated with embodiments of the present invention. Communication port 912 can be any of an RS-232 port for use with a modem-based dialup connection, a 10/100 Ethernet port, a Gigabit or 10 Gigabit port using copper or fiber, a serial port, a parallel port, or other existing or future ports. Communication port 912 may be chosen depending on a network, such a Local Area Network (LAN), Wide Area Network (WAN), or any network to which computer system connects.

Memory 906 can be Random Access Memory (RAM), or any other dynamic storage device commonly known in the art. Read-only memory 908 can be any static storage device(s) e.g., but not limited to, a Programmable Read Only Memory (PROM) chips for storing static information e.g., start-up or BIOS instructions for processor 914. Mass storage 910 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 904 communicatively couples the processor(s) 914 with the other memory, storage and communication blocks. Bus 904 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 914 to software system.

Optionally, operator and administrative interfaces, e.g. a display, keyboard, and a cursor control device, may also be coupled to bus 904 to support direct operator interaction with a computer system. Other operator and administrative interfaces can be provided through network connections connected through communication port 912. The external storage device 902 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other or in contact with each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

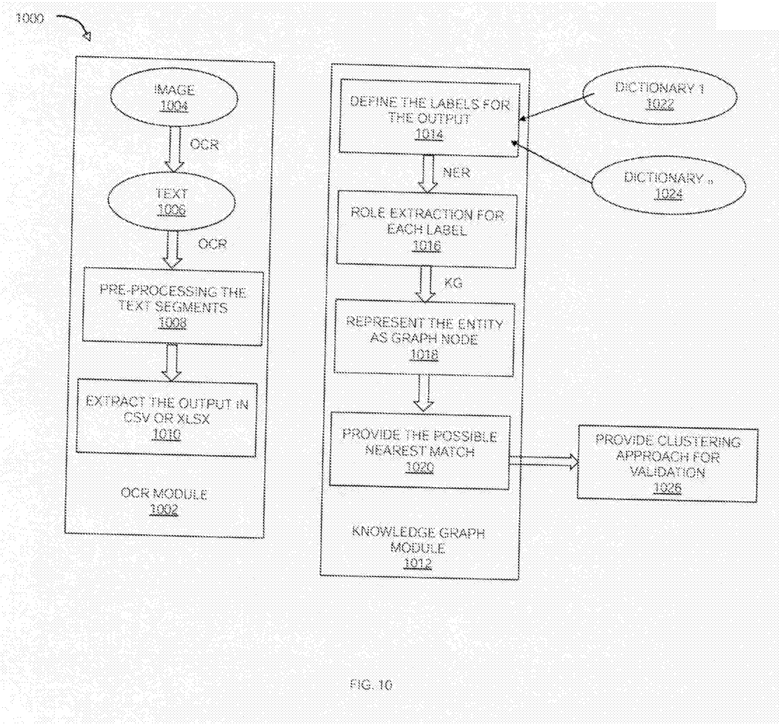

FIG. 10 illustrates architectural overview depicting a method for bot processing automation in accordance with an aspect of the present invention. The architecture 1000 includes an OCR module 1002, a knowledge graph module 1012. The data from the image 1004 is converted into text 1006 using the OCR technique. On obtaining the text content, the same is subjected to pre-processing multiple segments of the obtained text 1008 using the OCR technique. On pre-processing the multiple texts, an output in the form of CSV or XLSX is extracted in step 1010 from the OCR module.

Simultaneously, multiple labels are defined for an output in the knowledge graph module 1012 upon receiving data from multiple dictionaries starting from dictionary 1 1022 to dictionary n 1024 using an NER technique in step 1014. Further, a role extraction is performed for each of the multiple labels in step 1016 using the knowledge graph. Furthermore, each of multiple entities are represented as a graph node in step 1018, subsequently a nearest possible match is provided in step 1020. A clustering approach is provided for validation in step 1026.

### Advantages of the Invention

The present invention provides system and method for bot process automation using knowledge base in contextual artificial intelligence (AI).

The present disclosure also provides an end-to-end data processing for bot process automation without any human intervention.

The present disclosure provides tracking facility for an end user to know the status of the data processing.

The present disclosure provides a system and method for bot process automation to analyse input data for corresponding records of an entity.

The present disclosure provides a system and method for bot process automation which contribution towards increasing completeness of the process.

The present disclosure provides a system and method for bot process automation to improve the entity extraction and information access.

The present disclosure provides a system and method for bot process automation improve the quality of service of a system architecture.

The present disclosure provides an optimum use of the system with minimal efforts of human.

The present disclosure provides a cost effective in terms of technical specifications as the hardware and the services involved in the process automation is reduced.

The present disclosure provides a system and method for bot process automation which is more user friendly, more reliable, more transparent and more efficient.

The present disclosure provides an intelligence system to self-organize the bot with reasoning capability.

The present disclosure provides a system which performs auto correction of the text, based on the context using AI techniques.

What is claimed is:

1. A system for bot processing automation, said system comprising:
a processor;
a memory comprising a set of instructions, which when executed by the processor cause the processor to:
receive, from a repository, an image, and process said image using optical character recognition (OCR) to generate a first output;
process any or a part of said image and said generated first output using contextual artificial intelligence (AI) to generate a second output, said contextual AI being based on a combination of a neural network, one or more knowledge graphs, and natural language processing (NLP);
facilitate use of said second output and said one or more knowledge graphs for bot automation to validate and build interdependency among one or more fields that form part of said image.

2. The system as claimed in claim 1, wherein based on the validation and built interdependency, any or a combination of said neural network and said one or more knowledge graphs are updated to provision intelligence to said bot automation.

3. The system as claimed in claim 1, wherein at least one of said one or more knowledge graphs represents knowledge in an area of interest using a graph-like structure, said at least one knowledge graph being built on top of a plurality of existing databases so as to link data together by combining structured and unstructured information.

4. The system as claimed in claim 3, wherein said at least one knowledge graph is generated and updated based on deep learning enabled through said neural network, said NLP, said OCR, and said bot automation, wherein said at least one knowledge graph is processed to indicate any or a combination of geo-location of a user, demographic information associated with said user, a health attribute associated with said user, and one or more parameters pertaining to said user.

5. The system as claimed in claim 3, wherein the at least one knowledge graph is generated for or associated with a healthcare patient, and comprises interrelationships between name of the patient, location of the patient, and a unique subscriber identifier associated with said patient.

6. The system as claimed in claim 1, wherein said neural network comprises a knowledge matching engine that receives input features from a plurality of sources, and processes said input features using one or more hidden layers and computational units to generate output predictions that are used for updating said one or more knowledge graphs.

7. The system as claimed in claim 1, wherein any or both of said first and second outputs comprise textual data retrieved from said image.

8. The system as claimed in claim 1, wherein said bot automation is used for processing insurance claims.

9. The system as claimed in claim 1, wherein the processing of said image based on the OCR comprises:
pre-processing image data associated with said received image;
detecting any or a combination of lines, words or characters;
post-processing detected characters; and
rendering text as output based on the post-processed detected characters.

10. A method for bot processing automation, said method comprising:
receiving, from a repository, through a processor, an image, and processing said image using optical character recognition (OCR) to generate a first output;
processing any or a part of said image and said generated first output using contextual artificial intelligence (AI) to generate a second output, said contextual AI being based on a combination of a neural network, one or more knowledge graphs, and natural language processing (NLP); and
facilitating use of said second output and said one or more knowledge graphs for bot automation to validate and build interdependency among one or more fields that form part of said image.

11. The method as claimed in claim 10, wherein based on the validation and built interdependency, any or a combination of said neural network and said one or more knowledge graphs are updated to provision intelligence to said bot automation.

12. The method as claimed in claim 10, wherein at least one of said one or more knowledge graphs represents knowledge in an area of interest using a graph-like structure, said at least one knowledge graph being built on top of a plurality of existing databases so as to link data together by combining structured and to unstructured information.

13. The method as claimed in claim 12, wherein said at least one knowledge graph is generated and updated based on deep learning enabled through said neural network, said NLP, said OCR, and said bot automation, wherein said at least one knowledge graph is processed to indicate any or a combination of geo-location of a user, demographic information associated with said user, a health attribute associated with said user, and one or more parameters pertaining to said user.

14. The method as claimed in claim 12, wherein the at least one knowledge graph is generated for or associated with a healthcare patient, and comprises interrelationships between name of the patient, location of the patient, and a unique subscriber identifier associated with said patient.

15. The method as claimed in claim 10, wherein said neural network comprises a knowledge matching engine that receives input features from a plurality of sources, and processes said input features using one or more hidden layers and computational units to generate output predictions that are used for updating said one or more knowledge graphs.

16. The method as claimed in claim 10, wherein any or both of said first and second outputs comprise textual data retrieved from said image.

17. The method as claimed in claim 10, wherein said bot automation is used for processing insurance claims.

18. The method as claimed in claim 10, wherein the processing of said image based on the OCR comprises:
pre-processing image data associated with said received image;
detecting any or a combination of lines, words or characters;
post-processing detected characters; and
rendering text as output based on the post-processed detected characters.
